(19) United States
(12) Patent Application Publication
(10) Pub. No.: US 2026/0208796 A1
(43) Pub. Date: Jul. 23, 2026

(54) VEHICLE WITH STORAGE ARRANGEMENT

(71) Applicant: BOMBARDIER RECREATIONAL PRODUCTS INC., Valcourt (CA)

(72) Inventors: Nicolas LABERGE, Magog (CA); Erik Carl Gustav EVERS, Bromont (CA); Andre COTE, Hatley (CA)

(21) Appl. No.: 19/139,973

(22) PCT Filed: Dec. 22, 2023
(86) PCT No.: PCT/IB2023/063202

§ 371 Date: Jun. 17, 2025

Related U.S. Application Data
(60) Provisional application No. 63/435,182, filed on Dec. 23, 2022.

(51) Int. Cl. B62D 25/20; B60K 1/00; B60L 50/60; B60N 2/01; B60N 2/30; B60R 5/02; B60R 5/04

(52) U.S. Cl. CPC B62D 25/20; B60K 1/00; B60L 50/60; B60N 2/01; B60N 2/3047; B60R 5/02; B60R 5/04

(57) ABSTRACT

A vehicle including a frame; a vehicle body; a passenger compartment; a passenger compartment floor being generally flat; a motor; wheels relatively connected to the frame, at least one wheel operatively connected to the motor; at least one front seat disposed in the passenger compartment, at least one front legroom space being defined forward of the at least one front seat in the passenger compartment; and at least one rear seat disposed in the passenger compartment, the at least one rear seat being disposed rearward of the at least one front seat, a rear legroom space being defined longitudinally between the at least one rear seat and the at least one front seat, a storage volume extending continuously from rearward of the rear seat, below the rear seat, through the rear legroom space, and under at least a portion of the at least one front seat.

### CROSS-REFERENCE

The present application claims priority to U.S. Provisional Patent Application No. 63/435,182, entitled “Vehicle with Storage Arrangement”, filed Dec. 23, 2022, the entirety of which is incorporated by reference herein.

### FIELD OF TECHNOLOGY

The present technology relates to vehicles, more specifically to electric automobiles, with storage arrangements.

### BACKGROUND

Passenger vehicles, specifically automobiles, are arranged to transport a driver and one or more passengers. Along with passengers often comes baggage and/or belongings of various forms to be transported, from simple personal effects to sporting equipment, tools, and shopping. Automobiles are thus often arranged with a rear storage space (trunk) which is fully enclosed, such as for a sedan style car, or in a space between a last row of seats and a rear, such as for a sports utility vehicle or station wagon. As electric automobiles become more common, arrangements such as front trunks (“frunks”) are also increasingly being used to add storage capacity in such vehicles.

In smaller cars, including for two-door vehicles, overall storage capacity can sometimes be limited. Capacity to transport large objects within the vehicle can be especially difficult, as the size of item transported is often limited to the dimensions of the trunk or frunk.

There thus remains a desire for vehicle arrangements addressing at least some of the above described disadvantages.

### SUMMARY

It is an object of the present technology to ameliorate at least some of the inconveniences present in the prior art.

According to one aspect of the present technology, there is provided a two-door electric automobile. The vehicle is arranged with a storage space extends continuously rearward from below the front seats, under the rear seats (in this case a rear bench seat), and rearward into a space rearward of the rear seats. The rear bench seat is supported on lateral outward ends by the vehicle body, providing a continuous laterally extending storage pace below the rear bench seat. The present vehicle is built on a skateboard electric chassis, which has a generally flat top surface. The floor of the passenger compartment is thus also generally flat, providing a flat bottom surface (floor) for the continuous storage space extending below the rear seats and forward under the front seats. As no mechanism for folding and sliding the front seats to allow access to the rear seats is required, the positioning mechanisms for the front seats are simplified. The simplified structure of the present vehicle arrangement provides additional storage space below each of the front seats.

According to one aspect of the present technology, there is provided a vehicle including a frame; a vehicle body formed at least in part by the frame; a passenger compartment defined at least in part by the vehicle body; a passenger compartment floor formed at least in part by at least one of the frame and the vehicle body, the passenger compartment floor being generally flat; at least one motor supported by the frame; a plurality of wheels rotatively connected to the frame, at least one of the plurality of wheels being operatively connected to the at least one motor; at least one front seat disposed in the passenger compartment, at least one front legroom space being defined forward of the at least one front seat in the passenger compartment; and at least one rear seat disposed in the passenger compartment, the at least one rear seat being disposed rearward of the at least one front seat, a rear legroom space being defined longitudinally between the at least one rear seat and the at least one front seat, a storage volume being defined in part by the passenger compartment floor and an underside of the at least one rear seat, the storage volume extending continuously from rearward of the at least one rear seat, below the at least one rear seat, through the rear legroom space, and under at least a portion of the at least one front seat.

In some embodiments, the at least one rear seat is a rear bench seat configured to seat a plurality of passengers, the rear bench seat extending laterally over a width of the passenger compartment; and the storage volume extends continuously laterally along the floor under the rear seat bench.

In some embodiments, the rear bench seat is supported by the frame, lateral ends of the rear bench seat being connected to opposite lateral sides of the frame; and the storage volume extends continuously laterally under the rear seat bench from a left side of the passenger compartment to a right side of the passenger compartment.

In some embodiments, the rear bench seat includes: a seatback, and a seating portion pivotally connected to the seatback, the seating portion being selectively moveable between at least a lowered position and a lifted position; and the storage volume is defined in part by an underside of the seating portion when in the lowered position.

In some embodiments, a portion of the storage volume further extends at least partially upward between the at least one front seat and the rear bench when the seating portion is in the lifted position.

In some embodiments, the at least one front seat includes: a driver seat disposed forward of the rear bench, and a front passenger seat disposed forward of the rear bench; and the storage volume extends below a portion of the driver seat, the storage volume being further defined in part by an underside of the driver seat.

In some embodiments, the at least one front legroom space includes: a first legroom space defined forward of the driver seat, and a second legroom space defined forward of the front passenger seat.

In some embodiments, the vehicle further includes a wall disposed below the driver seat, the wall extending from the floor to an underside of the driver seat, the wall separating the first legroom from the storage space.

In some embodiments, the storage volume further extends continuously forward under the front passenger seat and into the second legroom space.

In some embodiments, the vehicle is an electric vehicle.

In some embodiments, the frame includes a chassis, and an upper body frame connected to and extending upward from the chassis; and the chassis and the upper body frame form, at least in part, the vehicle body.

In some embodiments, the chassis is a skateboard chassis including the at least one motor, and a battery system operatively connected to the at least one motor for powering the at least one motor.

In some embodiments, the passenger compartment floor is formed over a top surface of the skateboard chassis.

In some embodiments, the vehicle body further includes a plurality of body panels connected to the upper body frame.

In some embodiments, the at least one front seat includes: a driver seat disposed on a first side of a longitudinal center plane of the vehicle; and a front passenger seat disposed on a second side of the longitudinal center plane.

In some embodiments, the at least one rear seat is a rear bench seat configured to seat a plurality of passengers, the rear bench seat extending laterally over at least a majority of a width of the passenger compartment.

In some embodiments, the vehicle is an automobile; and the plurality of wheels includes two front wheels and two rear wheels.

For the purposes of the present application, terms related to spatial orientation such as forward, rearward, front, rear, upper, lower, left, and right, are as they would normally be understood by a driver of the vehicle sitting therein in a normal driving position with the vehicle being steered in a straight ahead direction.

Embodiments of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of embodiments of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a left side elevation view of an electric automobile according to a non-limiting embodiment of the present technology;

FIG. 2 is a top plan view of the vehicle of FIG. 1;

FIG. 3 is a partial, cross-sectional view of the vehicle of FIG. 1, taken along line 3-3 of FIG. 2;

FIG. 4 is a perspective, schematic view of a chassis of the vehicle of FIG. 1;

FIG. 5 is a top, rear, left side perspective view of portions of an upper body frame of the vehicle of FIG. 1;

FIG. 6 is a bottom, rear, left side perspective view of the upper body frame portions of FIG. 5;

FIG. 7 is a partial, cross-sectional view of the vehicle of FIG. 1, taken along line 7-7 of FIG. 1;

FIG. 8 is a left side elevation view of a central portion of the vehicle of FIG. 1, with a left side door of the vehicle being in an open position;

FIG. 9 is a left side elevation view of the center portion of the vehicle of FIG. 1, with doors of the vehicle having been removed;

FIG. 10 is a partial, cross-sectional view of the vehicle of FIG. 1, taken along line 10-10 of FIG. 1;

FIG. 11 is the partial, cross-sectional view of the vehicle of FIG. 10, with different areas identified;

FIG. 12 is a top plan view of a portion of the vehicle of FIG. 1, with a top portion of the frame removed to show an interior of the vehicle; and

FIG. 13 is a cross-sectional view of the vehicle portion of FIG. 12, taken along line 13-13 of FIG. 12.

It should be noted that, unless otherwise explicitly specified herein, the drawings are not necessarily to scale.

### DETAILED DESCRIPTION

The vehicle 100 illustrated herein is a two-door electric automobile 100. It is contemplated that vehicles according to the present technology could vary by a plurality of vehicle characteristics. These vehicle characteristics could include, but are not limited to, a car type (sedan, coupe, etc.), tire type, a wheelbase, rear storage access (hatch back or trunk).

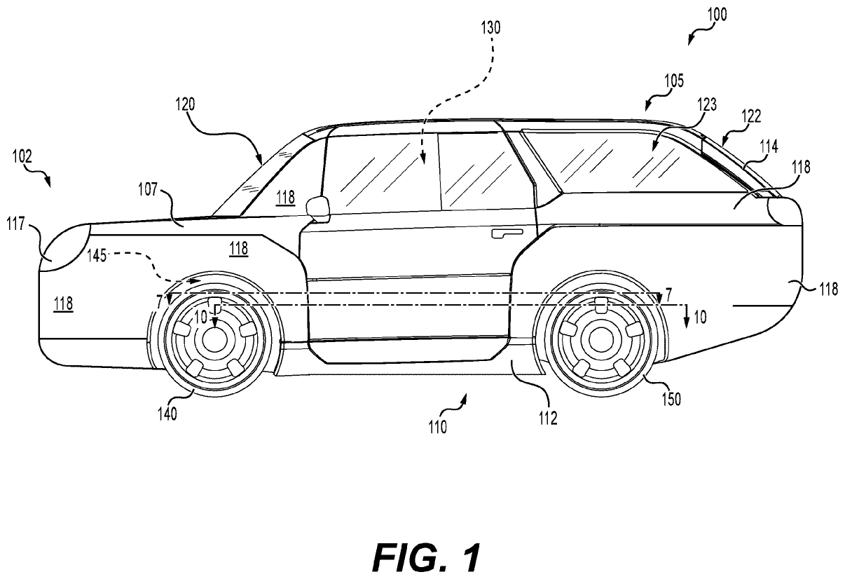

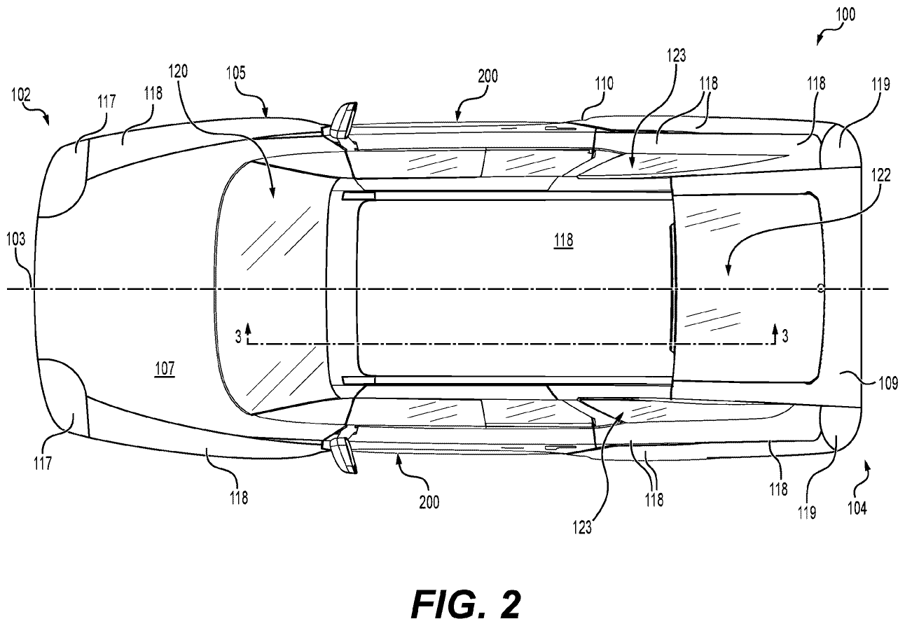

The general features of an electric automobile 100, referred to herein as the vehicle 100, will be described with respect to FIGS. 1 and 2. The vehicle 100 has a front end 102, a rear end 104, and a longitudinal center plane 103 defined consistently with the forward travel direction of the vehicle 100. The vehicle 100 has a vehicle body 105 defining the form and extent of the vehicle 100. In the present embodiment, the vehicle 100 is illustrated with a generally station wagon style vehicle body 105. It is contemplated that in different embodiments implementing the present technology, the vehicle body 105 could be of a variety of types, including but not limited to: hatchback, sports utility vehicle (SUV), sedan, multi-purpose vehicle (MPV), city car style, coupe, compact, and subcompact.

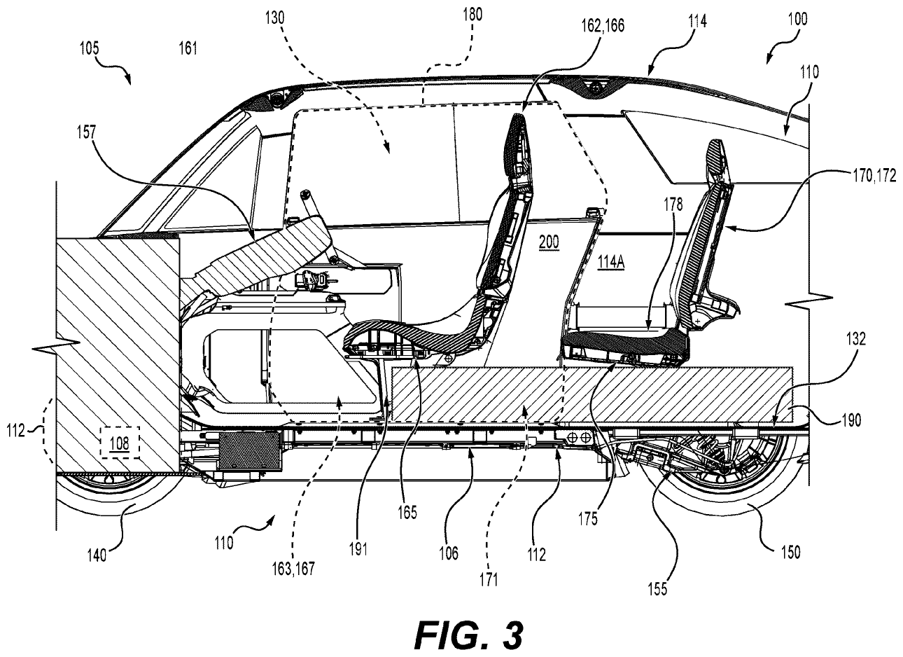

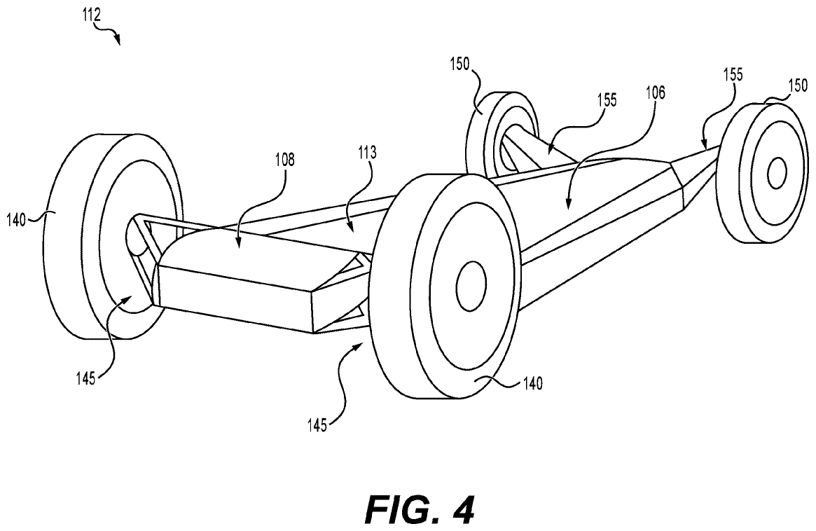

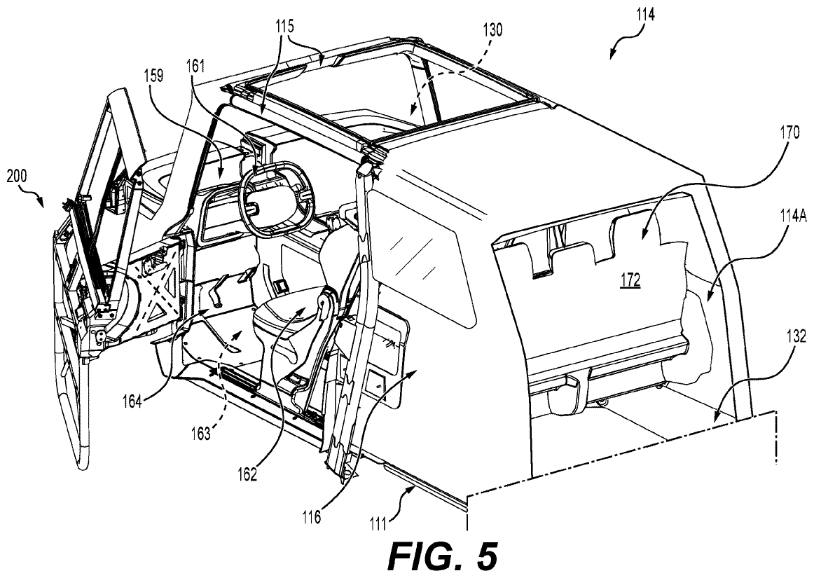

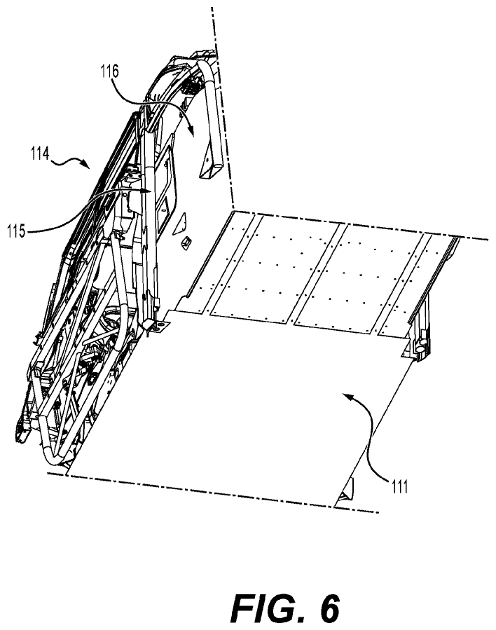

With additional reference to FIG. 3, the vehicle 100 has a frame 110, also referred to as a frame assembly 110. The frame 110 supports and forms, in part, the vehicle body 105. By the present technology, the frame 110 is formed from two parts: a lower base structure provided by a rolling platform type chassis 112 (FIG. 4) and an upper body frame 114 connected to and extending from the chassis 112 (FIGS. 5 and 6). Portions of the chassis 112 and the upper body frame 114 can also be seen in cross-section in FIG. 3.

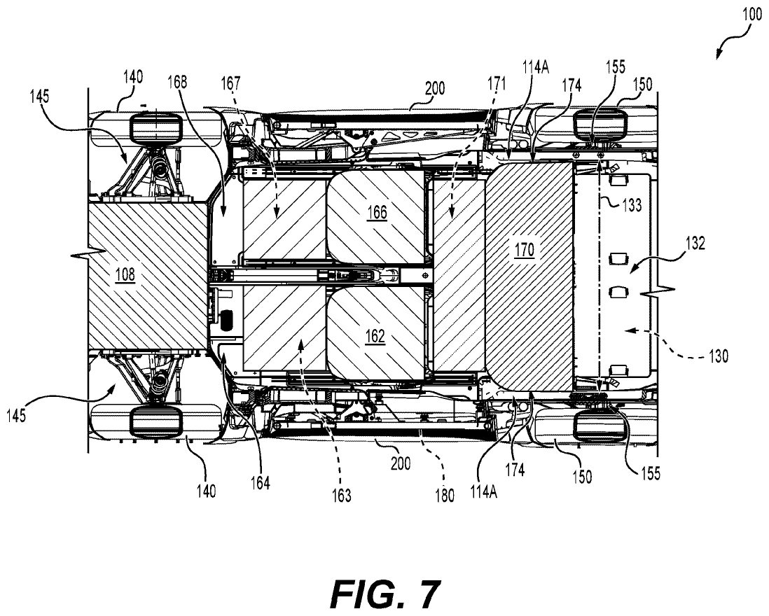

The chassis 112 forms the rigid base structure of the frame 110. The rolling platform type chassis 112 has a generally horizontal structure to which the vehicle wheels are connected. Specifically, the vehicle 100 has two front wheels 140 connected to a front of the chassis 112 by front suspension assemblies 145 (see also FIG. 7). The vehicle 100 also includes two rear wheels 150 connected to a rear of the chassis 112 by rear suspension assemblies 155 (see also FIG. 7).

In the present embodiment, the rolling platform chassis 112 is specifically an electric-vehicle skateboard-type chassis 112. The chassis 112 includes a battery system 106 for providing power to the vehicle 100. The battery system 106 is packaged into a central portion of the chassis 112. The battery system 106 thus extends across a generally horizontal plane on a bottom side portion of the vehicle 100. Without limitation, it is contemplated that the battery system 106 could include, but is not limited to: batteries and/or battery cells, a charger, an inverter, etc.

The skateboard chassis 112 also includes an electric motor 108 connected thereto. The motor 108 is disposed in a forward portion of the chassis 112 for driving the front wheels 140. The chassis 112 includes a drivetrain (not shown) connecting the motor 108 to the wheels 140. It is contemplated that the motor 108 could be disposed in a rearward portion of the chassis 112 for driving the rear wheels 150. It is further contemplated that the chassis 112 could include two motors, one for driving each pair of wheels 140, 150. It is further contemplated that a drivetrain connecting the forwardly disposed motor 108 to the rear wheels 150 could be included in some embodiments. It is further contemplated that four motors could be provided, one for each wheel, including but not limited to direct-drive in-wheel type motors, also referred to as “hub motors”.

The motor 108 and the battery system 106 are packaged into the skateboard chassis 112, such that the structure of the chassis 112, the motor 108, and the battery system 106 form a unit. The battery system 106 is operatively connected to the motor 108 for providing power thereto, electrical connections (not shown) being encased in the body of the chassis 112.

Illustrated in isolation in FIGS. 5 and 6, the upper body frame 114 is formed from both a plurality of hollow frame tubes 115 and a unibody portion 116. It is contemplated that the upper body frame 114 could be formed entirely from a unibody or entirely from frame tubes 115. It is also contemplated that multiple unibody type structures could be included in the upper body frame 114.

The upper body frame 114 is connected to and extends upward from a top surface 113 of the chassis 112. Specifically, a generally flat bottom portion 111 of the upper body frame 114 is disposed on the generally flat chassis top surface 113. The bottom portion 111 is specifically defined by the unibody portion 116, although a separate floor structure could be included in some embodiments. In the present embodiment, the upper body frame 114 is welded to the chassis 112, but different methods of connecting the chassis 112 and the upper body frame 114 are contemplated, such as bolts and adhesives.

In the illustrated embodiment, the vehicle 100 further includes a forward subframe (not shown) and a rearward subframe (not shown) defining forward and rearward portions of the vehicle body 105.

Returning to FIGS. 1 and 2, the vehicle 100 further includes body panels 118 for defining, in part, the vehicle body 105. The body panels 118 are connected to the frame 110, specifically to the upper body frame 114, as well as to the forward and rearward subframes. The panels 118 help protect the internal components of the vehicle 100, provide aerodynamic features, and provide some of the aesthetic features of the vehicle 100.

Forwardly disposed panels 118 define two apertures inside which two front illumination assemblies 117 of the vehicle 100 are disposed. The front illumination assemblies 117 include front headlamps, front turn indicator lamps, and front high beams (not separately identified). Depending on the embodiment, additional or alternative front lights could be included in the front illumination assemblies 117. It is also contemplated that the panels 118 could define additional apertures for receiving additional separate front illumination or reflective components.

Rearwardly disposed panels 118 define two apertures inside which two rear illumination assemblies 119 of the vehicle 100 are disposed. The rear illumination assemblies 119 include brake lights, rear turn indicator lamps, and reverse indicator lamps (not separately identified). Depending on the embodiment, additional or alternative rear lights could be included in the rear illumination assemblies 119. It is also contemplated that the panels 118 could define additional apertures for receiving additional separate rear illumination or reflective components.

The vehicle body 105 also includes a front hood 107 pivotally connected to the frame 110 for selectively providing access to at least some forward vehicle components. The vehicle body 105 also includes a rear door 109 for selectively closing a rear side of the vehicle interior. Depending on the particular embodiment, including for example vehicle body type, the hood 107 and/or the door 109 could have different forms. It is also contemplated that the hood 107 and/or the door 109 could be replaced by immovable body panels 118 in some embodiments. It is further contemplated that other storage spaces closed by respective movable panels, instead of or in addition to the front hood 107 and/or rear door 109, could be provided in some embodiments.

The vehicle body 105 includes a front windshield 120 extending laterally across a forward portion of the upper body frame 114. The vehicle body 105 also includes a rear window 122 extending laterally across a rearward portion of the upper body frame 114. The vehicle body 105 further includes two rear side windows 123, one window 123 being disposed on each side of the vehicle 100. Depending on the particular car type of a given embodiment of the vehicle 100, the rear side windows 123 could be omitted in some cases. It is also contemplated that additional side windows could be included in different embodiments.

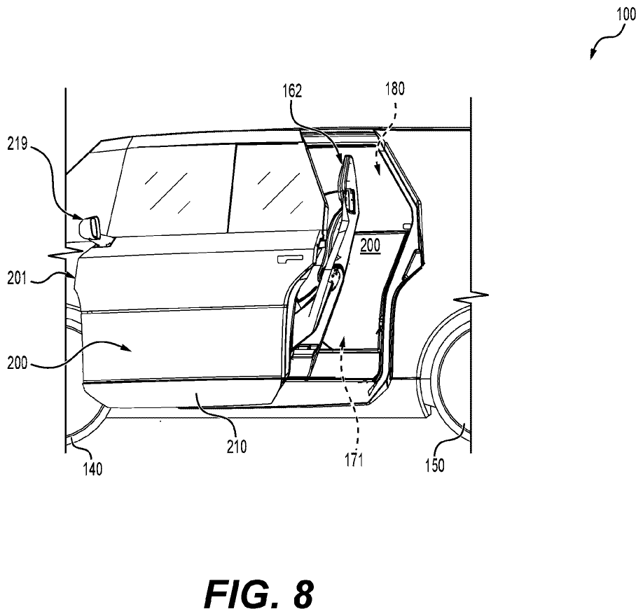

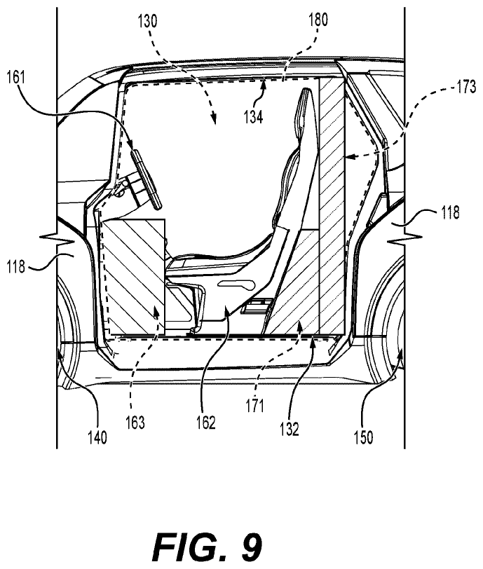

With reference to FIGS. 8 and 9, the vehicle body 105 also defines therein two openings 180 through which a driver or passenger can enter or exit the vehicle 100. A right side opening 180 is defined in a right side of the vehicle body 105 and a left side opening 180 is defined in a left side of the vehicle body 105. The right side opening 180 is selectively closed by a right side door 200 movably connected to a right side the vehicle body 105. The left side opening 180 is selectively closed by a left side door 200 movably connected to a left side the vehicle body 105.

The vehicle 100 includes a passenger compartment 130, inside which passengers (including a driver) of the vehicle 100 are situated during operation of the vehicle 100. The passenger compartment 130 is defined by the vehicle body 105. Specifically, the passenger compartment 130 is defined by an interior surface of the upper body frame 114 and the body panels 118 connected thereto. While not illustrated explicitly, the interior surface of the vehicle body 105 defining the passenger compartment 130 is generally covered with surface finishing materials, including but not limited to: carpeting, plastic and/or wood paneling, liner fabric, and insulating materials.

A floor 132 of the passenger compartment 130 is formed by a top surface of the bottom portion 111 of the upper body frame 114. Although not specifically illustrated, it is contemplated that the floor 132 defined by the bottom portion 111 is generally covered by noise and/or heat insulating material and automotive carpeting. As is mentioned above, the bottom portion 111 is formed over the top surface 113 of the skateboard chassis 112 and is generally flat. The floor 132 of the passenger compartment 130 is similarly generally flat along a longitudinal length of the passenger compartment 130, being formed upon the bottom portion 111 of the upper frame body 114.

As can be seen in FIGS. 7 to 9 and 12, the vehicle 100 includes two front seats disposed in the passenger compartment 130. Specifically, the vehicle 100 includes a driver seat 162 and a front passenger seat 166. In the present embodiment, the driver seat 162 is disposed on the left side of the center plane 103 and the passenger seat 166 is disposed on the right side of the center plane 103. It is contemplated, however, that the driver seat 162 could be disposed on the right side of the vehicle 100 and that the passenger seat 166 could be disposed on the left side of the vehicle 100. The seats 162, 166 each include a seat position adjustment mechanism (not shown) for providing at least forward and rearward position adjustment. The seat position adjustment mechanisms included in the vehicle 100 are configured and arranged to adjust ergonomics of the corresponding seat 162, 166, specifically by adjusting a forward/rearward position to accommodate drivers and riders of different heights or for different preferred positions of the driver/rider. It is noted that ergonomic adjustment directed position adjustment systems generally have a more limited range of motion compared to a clearance directed seat position system, where seats are configured to move out of the way to allow entry of a passenger to a rear portion of the vehicle. It is also noted that an ergonomic seat position system is generally lighter and less mechanically complicated than access-providing seat movement (often tip or tilting the seat). The present technology allows for use of the simpler ergonomic seat position system while still providing access to the rear seats. In some embodiments, only the driver seat 162 may be provided with the seat position adjustment mechanism.

The vehicle 100 includes two front legroom spaces defined in the passenger compartment 130, as is illustrated in FIG. 7. Passengers of the vehicle 100 generally enter the passenger compartment 130 through the legroom spaces and position their legs therein when occupying the front seats 162, 166. Specifically, a driver side front legroom space 163 is defined forward of the driver seat 162 in the passenger compartment 130. A passenger side front legroom space 167 is defined forward of the passenger seat 166 in the passenger compartment 130. A rear side of each legroom space 163, 167 is generally defined by the corresponding seat 162, 166. A front side of each legroom space 163, 167 is generally defined by a front, interior side of the vehicle body 105. A driver side footwell 164 defines at least a portion of a forward extent of the driver side front legroom space 163. A passenger side footwell 168 defines at least a portion of a forward extent of the passenger side front legroom space 167. It is contemplated that additional or alternative structures or components could define the legroom spaces 163, 167. For example, structures defining the front side of each legroom space 163, 167 could include, but is not limited to: a dashboard, a glove box, and a center console.

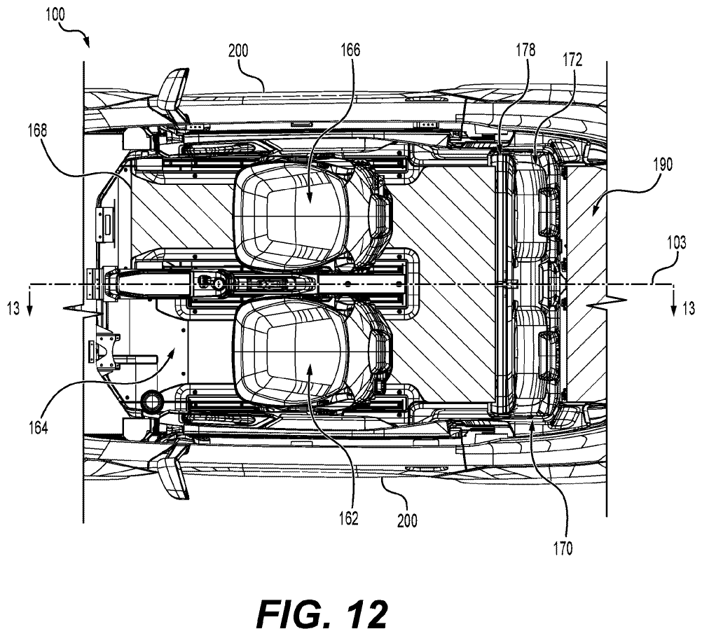

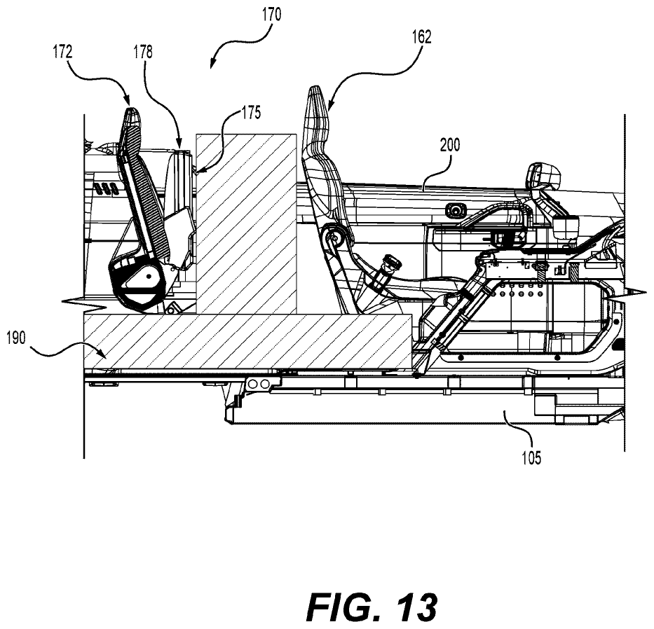

The vehicle 100 further includes rear seating, also referred to as a second row of seating. In the illustrated embodiment, the vehicle 100 includes a rear bench seat 170 disposed in the passenger compartment 130. The rear bench seat 170 is disposed rearward of the front seats 162, 166. The rear bench seat 170 configured to seat a plurality of passengers. In the illustrated embodiment, the rear bench seat 170 is arranged to seat three passengers. In at least some embodiments, the rear bench seat 170 could be configured to receive and seat two passengers. In at least some embodiments it is contemplated that the rear bench seat 170 could be replaced with two or three individual rear seats. In the illustrated embodiment, the rear bench seat 170 includes a seatback 172 and a seating portion 178. The seating portion 178 is pivotally connected to the seatback 172. The seating portion 178 is selectively moveable between a lowered position (FIG. 7) and a lifted position (FIGS. 12, 13).

As is shown in FIG. 7, the rear bench seat 170 extends laterally over at least a majority of a width 133 of the passenger compartment 130. The rear bench seat 170 is supported by the upper body frame 114, specifically lateral, generally vertically extending side portions 114A (walls 114A) of the upper body frame 114. Lateral ends 174 of the seatback 172 are connected to opposite lateral sides 114A of the upper body frame 114. As such, the rear bench seat 170 extends laterally over an entirety of the width 133 of the passenger compartment 130 in the illustrated embodiment. It is contemplated that the rear bench seat 170, or other implementations of rear seating, could be differently installed in the passenger compartment 130, for example using vertically extending seating legs connected to the floor 132 of the passenger compartment 130.

The vehicle 100 also includes a rear legroom space 171 defined longitudinally between the rear bench seat 170 and the front seats 162, 166. The rear legroom space 171 extends laterally through the passenger compartment 130 (see for example FIGS. 7 to 9). When the seating portion 178 is in the lifted position, the legroom space 171 extends further rearward although it is noted that “legroom” is not a particularly useful term as no passengers can be seated on the seat 170 when in the lifted position. In at least some embodiments, it is contemplated that the rear legroom space 171 could be laterally interrupted by additional components disposed longitudinally between the front seats 162, 166 and the rear bench seat 170. For example, a center console could be disposed between the front seats 162, 166 and extend rearward at least partially into the rear legroom space 171.

Returning to FIG. 9, a rear free space 173 is further defined in the passenger compartment 130 between the front seats 162, 166 and the rear bench seat 170. When entering or exiting the vehicle 100 through one of the openings 180, passengers can move their body through the rear free space 173 to occupy or leave the rear bench seat 170. The rear free space 173 extends from the floor 132 of the passenger compartment 130 and a top interior surface 134 of the passenger compartment 130. The rear free space 173 is disposed longitudinally between the front seats 162, 166 and the rear bench seat 170. The rear free space 173 further extends laterally across the passenger compartment 130 in the present embodiment. It is contemplated, however, that one or more components could be disposed in a center portion of the passenger compartment 130, interrupting the continuous lateral extent of the rear free space 173. As illustrated by the cross-hatched illustration in FIG. 9, the rear free space 173 includes at least a portion of the rear legroom space 171.

The vehicle 100 includes additional components disposed in the passenger compartment 130 for operation by and accommodation of passengers of the vehicle 100. A steering wheel 161 is disposed in front of the driver seat 162. The steering wheel 161 is used to turn the front wheels 140 to steer the vehicle 100 via a steering assembly 157 (shown in cross-section in FIG. 3). A driver display 159, including various displays and gauges, is disposed above and forward the steering wheel 161 to provide information to the driver regarding the operating conditions of the vehicle 100. Examples of displays and gauges in the driver display 159 include, but are not limited to, a speedometer, a battery state of charge, a vehicle range, and a vehicle drive mode (park, drive, reverse), as well as symbols indicating the activation of turn signals, head lights, a parking brake, a regenerative braking level and various fault conditions (for example, high battery temperature, low battery, limited power, and electrical fault). Additional components are contemplated to be included in the passenger compartment 130, including but not limited to: a rear view mirror or screen, seat belts, navigational systems, heating systems, sound systems, storage compartments, and safety features.

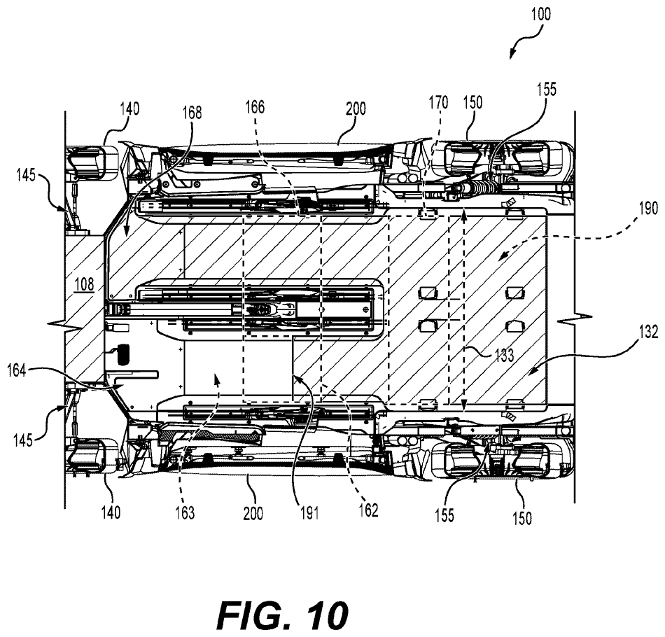

Returning to FIG. 3 and with additional reference to FIGS. 10 to 13, the vehicle 100 further includes a storage volume 190 defined in the passenger compartment 130. The storage volume 190 is formed by the arrangement of components disposed in the passenger compartment 130, including at least the front seats 162, 166 and the rear bench seat 170, as well as the form of the upper body frame 114.

The storage volume 190 is defined in part by the floor 132 of the passenger compartment 130, the floor 132 being generally flat as mentioned above. The lateral limits of the storage volume 190 are formed by the lateral sides 114A of the upper body frame 114. A portion of the storage volume 190 is defined by an underside 175 of the rear bench seat 170, specifically the underside 175 of the seating portion 178 when the seating portion 178 is in the lowered position. Upper limits on other portions of the storage volume 190 are further defined by an underside 165 of the driver seat 162 and an underside (not shown) of the front passenger seat 166. As can be seen in FIGS. 3, 10, and 11, there is additionally a wall 191 disposed below the driver seat 162 for limiting a forward extent of the storage volume 190. The wall 191 extends between the floor 132 and the underside 165 of the driver seat 162 (FIG. 3). The wall 191 separates the driver side legroom 163 from the storage space 190. The wall 191 may be perforated or solid. The wall 191 may also be rigid or flexible. The wall 191 may take the form of a net or mesh material.

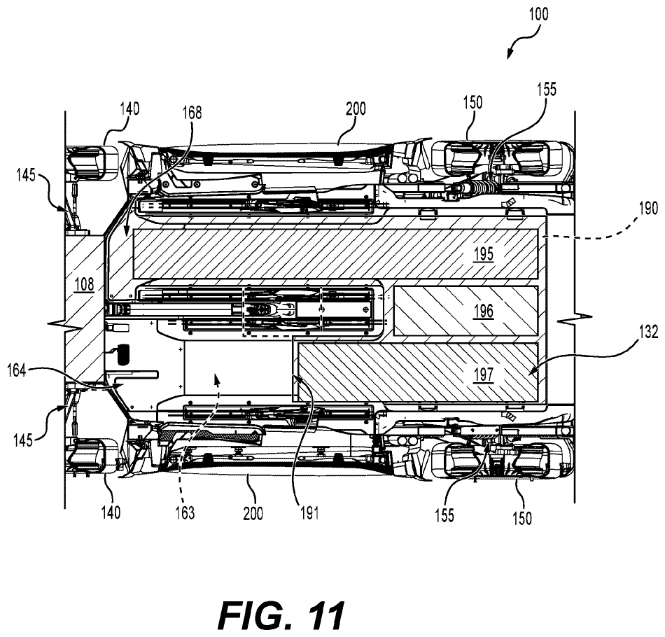

As is illustrated by the cross-hatching in FIGS. 10 and 11, the storage volume 190 extends continuously from rearward of the rear bench seat 170, below the rear bench seat 170, through the rear legroom space 171, and under a portion of the driver seat 162. With the generally flat passenger compartment floor 132 defining a bottom side of the storage volume 190, the vehicle 100 provides a generally flat and relatively large storage space to users of the vehicle 100.

The wall 191 limits the forward extent of the storage volume 190 on the left side of the center plane 103, as mentioned above. The wall 191 thus aids in preventing items stored to the storage volume 190 from sliding, rolling, etc. into the driver side footwell 164. On the right side of the center plane 103, the storage volume 190 further extends continuously forward under the front passenger seat 166 and into the passenger legroom space 167. It is contemplated that an additional wall could be included below the passenger seat 166 to limit the storage volume 190 in at least some cases.

As is described above, lateral ends 174 of the rear bench seat 170 are connected to lateral sides 114A of the upper body frame 114. No support structures are thus included below the rear bench seat 170 in this embodiment. As such, the storage volume 190 extends continuously laterally along the floor 132 under the rear bench seat 170. Specifically, the storage volume 190 extends continuously laterally under the rear seat bench 170 from a left side of the passenger compartment 130 to a right side of the passenger compartment 130 across the entire width 133 of the passenger compartment 130.

Three example storage layouts of different portions of the storage volume 190 are illustrated in FIG. 11. Along the passenger side, a storage space 195 extends from a rear of the vehicle 100 forward under the seats 170, 166 and into the passenger footwell 168. This storage space 195 allows for objects nearly as long as the interior space of the vehicle 100 to be carried by the vehicle 100. Storage spaces 196, 197 illustrate two other spaces for receiving objects for storage and/or transport. Due to physical obstruction by a center console (not separately identified) and the wall 191, the length of the storage spaces 196, 197 are shorter than the space 195. The different shapes of available storage space in the vehicle 100 could vary. As can be seen in FIG. 13, when the seating portion 178 is in the lifted position, a portion of the storage volume 190 further extends at least partially upward between a rear side of the front seats 162, 166 and forward of the rear bench 170. The portion of the storage volume 190 extending upward at least partially overlaps with the rear free space 173.

In the present embodiment of the vehicle 100, the front seats 162, 166 do not include mechanisms for flip/sliding or tip/sliding for providing passengers access the rear bench seat 170. Without such mechanisms installed on the front seats 162, 166, most of the volume below the front seats 162, 166 is open and available for storage space.

Modifications and improvements to the above-described embodiments of the present technology may become apparent to those skilled in the art. The foregoing description is intended to be exemplary rather than limiting. The scope of the present technology is therefore intended to be limited solely by the scope of the appended claims.

1. A vehicle comprising:
a frame;
a vehicle body formed at least in part by the frame;
a passenger compartment defined at least in part by the vehicle body;
a passenger compartment floor formed at least in part by at least one of the frame and the vehicle body, the passenger compartment floor being generally flat;
at least one motor supported by the frame;
a plurality of wheels rotatively connected to the frame, at least one of the plurality of wheels being operatively connected to the at least one motor;
at least one front seat disposed in the passenger compartment, at least one front legroom space being defined forward of the at least one front seat in the passenger compartment; and
at least one rear seat disposed in the passenger compartment, the at least one rear seat being disposed rearward of the at least one front seat, a rear legroom space being defined longitudinally between the at least one rear seat and the at least one front seat,
a storage volume being defined in part by the passenger compartment floor and an underside of the at least one rear seat,
the storage volume extending continuously from rearward of the at least one rear seat, below the at least one rear seat, through the rear legroom space, and under at least a portion of the at least one front seat.

2. The vehicle of claim 1, wherein:
the at least one rear seat is a rear bench seat configured to seat a plurality of passengers, the rear bench seat extending laterally over a width of the passenger compartment; and
the storage volume extends continuously laterally along the passenger compartment floor under the rear bench seat.

3. The vehicle of claim 2, wherein:
the rear bench seat is supported by the frame, lateral ends of the rear bench seat being connected to opposite lateral sides of the frame; and
the storage volume extends continuously laterally under the rear bench seat from a left side of the passenger compartment to a right side of the passenger compartment.

4. The vehicle of claim 3, wherein:
the rear bench seat includes:
a seatback, and
a seating portion pivotally connected to the seatback, the seating portion being selectively moveable between at least a lowered position and a lifted position; and
the storage volume is defined in part by an underside of the seating portion when in the lowered position.

5. The vehicle of claim 4, wherein a portion of the storage volume further extends at least partially upward between the at least one front seat and the rear bench seat when the seating portion is in the lifted position.

6. The vehicle of claim 2, wherein:
the at least one front seat includes:
a driver seat disposed forward of the rear bench seat, and
a front passenger seat disposed forward of the rear bench; and
the storage volume extends below a portion of the driver seat, the storage volume being further defined in part by an underside of the driver seat.

7. The vehicle of claim 6, wherein the at least one front legroom space includes:
a first legroom space defined forward of the driver seat, and
a second legroom space defined forward of the front passenger seat.

8. The vehicle of claim 7, further comprising a wall disposed below the driver seat, the wall extending from the passenger compartment floor to an underside of the driver seat, the wall separating the first legroom space from the storage volume.

9. The vehicle of claim 7, wherein the storage volume further extends continuously forward under the front passenger seat and into the second legroom space.

10. The vehicle of claim 1, wherein the vehicle is an electric vehicle.

11. The vehicle of claim 10, wherein:
the frame comprises:
a chassis, and
an upper body frame connected to and extending upward from the chassis; and
the chassis and the upper body frame form, at least in part, the vehicle body.

12. The vehicle of claim 11, wherein the chassis is a skateboard chassis comprising:
the at least one motor, and
a battery system operatively connected to the at least one motor for powering the at least one motor.

13. The vehicle of claim 12, wherein the passenger compartment floor is formed over a top surface of the skateboard chassis.

14. The vehicle of claim 11, wherein the vehicle body further comprises a plurality of body panels connected to the upper body frame.

15. The vehicle of claim 1, wherein the at least one front seat includes:
a driver seat disposed on a first side of a longitudinal center plane of the vehicle; and
a front passenger seat disposed on a second side of the longitudinal center plane.

16. The vehicle of claim 15, wherein the at least one rear seat is a rear bench seat configured to seat a plurality of passengers, the rear bench seat extending laterally over at least a majority of a width of the passenger compartment.

17. The vehicle of claim 1, wherein:
the vehicle is an automobile; and
the plurality of wheels includes two front wheels and two rear wheels.
